(19) United States
(12) Patent Application Publication
(10) Pub. No.: US 2008/0252237 A1
(43) Pub. Date: Oct. 16, 2008

(54) Method for driving a light source, backlight assembly for performing the method and display apparatus having the backlight assembly

(75) Inventors: Gi-Cherl Kim, Yongin-si (KR); Ho-Sik Shin, Bucheon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/080,613

(22) Filed: Apr. 4, 2008

(30) Foreign Application Priority Data
Apr. 12, 2007 (KR) 10-2007-0036021

(51) Int. Cl. H05B 37/02

(52) U.S. Cl. 315/360

(57) ABSTRACT

In a method for driving a light source, a backlight assembly for performing the method and a display apparatus having the backlight assembly, a light source is driven by an initial power until a first time when initial brightness of the light source decreases to a reference brightness. Then, the light source is driven by a first compensation power after the first time, so that the light source has first compensation brightness. When the brightness of the light source decreases to the reference brightness, a driving power applied to the light source is changed to compensate the brightness of the light source. Thus, the light source is driven to have uniform brightness over an extended length of time.

### CROSS-REFERENCE TO RELATED APPLICATIONS

This application claims priority under 35 U.S.C. §119 to Korean Patent Application No. 2007-36021, filed on Apr. 12, 2007 in the Korean Intellectual Property Office (KIPO), the contents of which are herein incorporated by reference in their entirety.

### BACKGROUND OF THE INVENTION

1. Field of the Invention

The present invention relates to a method for driving a light source, a backlight assembly for performing the method and a display apparatus having the backlight assembly. More particularly, the present invention relates to the method for driving the light source to have uniform brightness, a backlight assembly for performing the method and a display apparatus having the backlight assembly.

2. Description of the Related Art

Generally, a liquid crystal display (LCD) apparatus is thin, light weight and low in power consumption, and thus is used not only in a monitor, a laptop computer, or a mobile phone, but also in large-sized television receiver sets. The LCD apparatus includes an LCD panel displaying an image by using light transmissivity of a liquid crystal, and a backlight assembly disposed under the LCD panel to provide light to the LCD panel. In this case, the backlight assembly may include light emitting diodes (LEDs) as a light source.

Brightness of the LEDs generally decreases when the LEDs are being driven for many hours. For example, the LEDs may emit light with an initial relative brightness of 100%, but the brightness decreases as time increases.

Since the brightness of the LEDs gradually decreases as the driving time increases, the brightness of the image displayed through the LCD apparatus gradually decreases. Thus, the LCD apparatus may not display the image having uniform brightness throughout a warranty period.

### SUMMARY OF THE INVENTION

The present invention provides a method for driving a light source to maintain uniform brightness for a longer time via compensating a driving power.

The present invention also provides a backlight assembly for performing the method for driving the light source.

The present invention also provides a display apparatus having the backlight assembly.

In an example method for driving a light source according to the present invention, a light source is driven by an initial power until a first time when initial brightness of the light source decreases to a reference brightness. The light source is driven at a first compensation power level after the first time, so that the light source has a first compensation brightness. In this case, the first time is predetermined by brightness aging characteristics of the light source according to time and by the reference brightness.

Preferably, the reference brightness may be further predetermined using the brightness aging characteristics of the light source according to the time, to determine the first time.

Preferably, the reference brightness may be in a range between about 70% and about 90% of the initial brightness, and the first compensation brightness may be in a range between about 90% and about 100% of the initial brightness. The light source may include a light emitting diode (LED). The initial power may be changed to the first compensation power level by changing at least one of a duty width of a pulse width modulation (PWM) and an amplitude of a signal that controls the light source.

In addition, the light source may be driven by the first compensation power level until a second time when the first compensation brightness of the light source decreases to the reference brightness. The light source may be further driven by a second compensation power level after the second time, so that the light source has a second compensation brightness. In this case, the second compensation brightness may be substantially same as the first compensation brightness.

In an example backlight assembly according to the present invention, the backlight assembly includes a light source and a light source driving part, and may further include a light source characteristic memory part.

The emitting light source is preferably an LED. The light source driving part drives the light source by changing a driving power applied to the light source when brightness of the light source decreases to the reference brightness to compensate the brightness of the light source.

The light source characteristic memory part stores light source data corresponding to the brightness compensation and provides the light source data to the light source driving part. In this case, the light source data may include at least one of information on the reference brightness, information on the compensation brightness of the light source, and information on the number of changes of compensation of the light source. Alternatively, the light source data may include information on the time for compensating the brightness of the light source.

In an example display apparatus according to the present invention, the display apparatus includes a timing control part, a display unit and a backlight assembly.

The timing control part outputs an image control signal and a light source control signal in response to an external signal. The display unit outputs an image in response to the image control signal. The backlight assembly includes a light source and a light source driving part.

The light source emits light and provides the light to the display unit. The light source driving part drives the light source by changing a driving power applied to the light source when brightness of the light source decreases to a reference brightness in response to the light source control signal to compensate the brightness of the light source.

The display apparatus may further include a light source characteristic memory part storing light source data corresponding to brightness compensation of the light source and providing the light source data to the light source driving part. In this case, the timing control part may receive the light source data from the light source characteristic memory part, and may output the light source control signal corresponding to the light source data to the light source driving part. Alternatively, the light source driving part may receive the light source data from the light source characteristic memory part, and may drive the light source in response to the light source data.

According to the present invention, when the brightness of the driving source decreases to the reference brightness, the driving power applied to the driving source is changed to compensate the brightness of the driving source, so that the driving source may continue to maintain uniform brightness for an extended time.

### BRIEF DESCRIPTION OF THE DRAWINGS

The above and other features and advantages of the present invention will become more apparent by describing in detailed example embodiments thereof with reference to the accompanying drawings, in which:

FIG. 1 is a flow chart illustrating a method for driving a light source according to an example embodiment of the present invention;

FIG. 2 is a graph illustrating an aging variation of brightness of a light source according to time;

FIG. 3 is a graph illustrating the aging variation of the brightness of the light source according to an example embodiment of FIG. 2;

FIGS. 4A, 4B and 4C are waveform diagrams illustrating a process of increasing a driving power via increasing a duty width of a plus width modulation (PWM);

FIGS. 5A, 5B and 5C are waveform diagrams illustrating a process of increasing the driving power via increasing an amplitude of the PWM;

FIG. 6 is a block diagram illustrating a display apparatus according to an example embodiment of the present invention; and

FIG. 7 is a block diagram illustrating a display apparatus according to another example embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. For example, power, power level, average power and average power level may be commonly understood to have the same meaning, in the context of the disclosure. In particular, in the context of pulse width modulation (PWM), where either the pulse amplitude or the duty width is changed, the power, power level, average power and average power level are intended to have the same meaning.

Hereinafter, the present invention will be explained in detail with reference to the accompanying drawings.

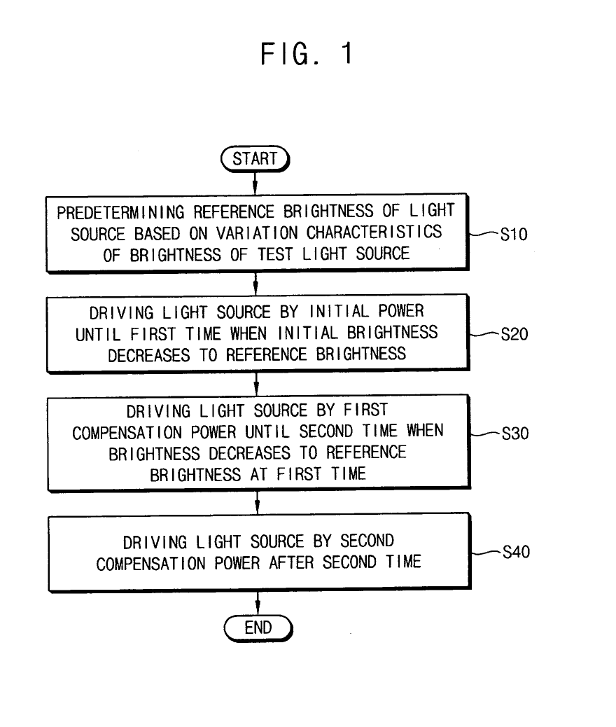

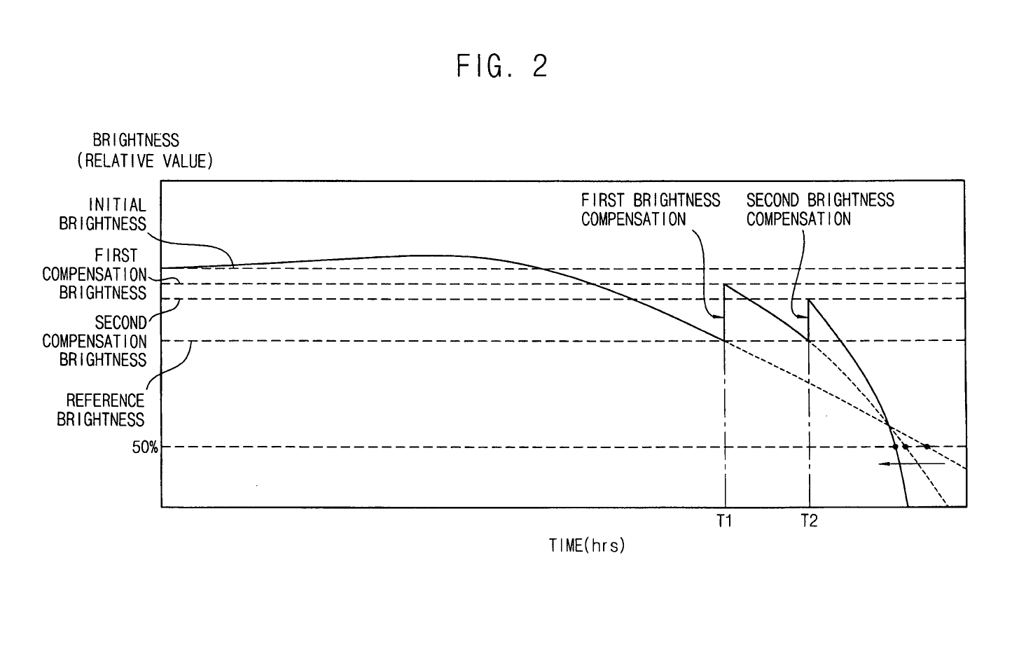

FIG. 1 is a flow chart illustrating a method for driving a light source according to an example embodiment of the present invention. FIG. 2 is a graph illustrating an aging variation of brightness of light source according to time.

In step S10, referring to FIGS. 1 and 2, reference brightness is predetermined based on brightness aging characteristics over time of a test light source.

The test light source is substantially the same kind of the light source that will be employed by a backlight assembly, and is preferably a light emitting diode (LED). Alternatively, the test light source and the light source may be a hot cathode fluorescence lamp (HCFL) or a cold cathode fluorescence lamp (CCFL).

The brightness aging characteristics of the test light source may be obtained via driving the test light source by a constant driving power for an extensive time and measuring the brightness aging variation of light emitted from the test light source according to the time. In accordance with the measured brightness aging characteristics of the test light source, the brightness of the light emitted from the test light source gradually decreases according to an increase of the time.

The reference brightness of the light source is a reference for compensating the driving power applied to the light source. For example, the reference brightness of the light source is preferably in a range of about 70% to about 90% of an initial brightness that is the brightness of the light emitted at an initial driving of the light source.

In step S20, after the reference brightness is determined, the light source is driven by an initial power until a first time T1 when the initial brightness decreases to the reference brightness.

The first time T1 corresponds to a time point at which the brightness of the light source declines to the reference brightness from the initial brightness. In addition, when the reference brightness is predetermined, the first time T1 is automatically determined by the brightness aging characteristics of the test light source.

When the light source is driven at the initial power during the first time interval up to T1, the brightness of the light source may slightly increase at the initial brightness and then gradually decrease as time progresses, to the reference brightness at the first time T1.

In step S30, the light source is driven by a first compensation power level larger than the initial power level until a second time T2 when the brightness of the light source decreases again to the same reference brightness as at the first time T1, so that the light source is driven to have a first compensation brightness larger than the reference brightness.

For example, at the first time T1 when the brightness of the light source decreases to the reference brightness, the first compensation power level larger than the initial power level is applied to the light source, so that the light source is driven to have the first compensation brightness larger than the reference brightness. Then, the light source is driven at the first compensation power level until the second time T2 when the first compensation brightness decreases, again, to the reference brightness.

The second time T2 corresponds to a time point at which the brightness of the light source declines to the reference brightness from the first compensation brightness. In addition, when the reference brightness is predetermined, the second time T2 is automatically determined by the brightness aging characteristics of the test light source.

For example, the first compensation brightness may be in the range of about 90% to about 100% of the initial brightness.

In step S40, after the second time T2, the light source is driven by a second compensation power level larger than the first compensation power level, so that the light source is driven to have a second compensation brightness larger than the reference brightness.

For example, at the second time T2, when the brightness of the light source decreases to the reference brightness, the second compensation power level larger than the first compensation power level is applied to the light source, so that the light source is driven to have the second compensation brightness larger than the reference brightness. In addition, the light source is continuously driven by the second compensation power level after the second time T2. As a result, following the second time T2, the light source, as driven, may have a continuously decreasing brightness from the second compensation brightness until the end of its lifespan.

For example, the second compensation brightness may be substantially same as the first compensation brightness, for example, in the range of about 90% to about 100% of the initial brightness.

When the light source is driven by a driving power level larger than that described above, the brightness of the light source may degrade rapidly. For example, the brightness of the light source decreases more rapidly when the light source is driven at the first driving power level than when the light source is driven at the initial power level. In addition, the brightness of the light source decreases more rapidly when the light source is driven at the second driving power level than when the light source is driven at the first driving power level.

Thus, the lifespan of the light source may decrease according the increase of the driving power level. In this case, the lifespan of the light source may correspond to a time when the light source decreases from the initial brightness to about 50% of the initial brightness.

In addition, the light source is compensated twice as an example embodiment in FIGS. 1 and 2. Alternatively, the light source may be compensated more than twice, or just once only. For example, the number of the compensations of the light source may be determined based on the brightness aging characteristics of the test light source.

In this case, when the number of the compensations of the light source increases, the brightness of the light emitted from the light source may be made more uniform, but the life span of the light source may decrease more quickly as the driving power levels increase.

However, as technology for the light source progresses, the lifespan of the light source may increase, so that the number of the compensations may be maximized based on an extended lifespan of the light source at least up to its lifespan covered by a warranty period for the brightness.

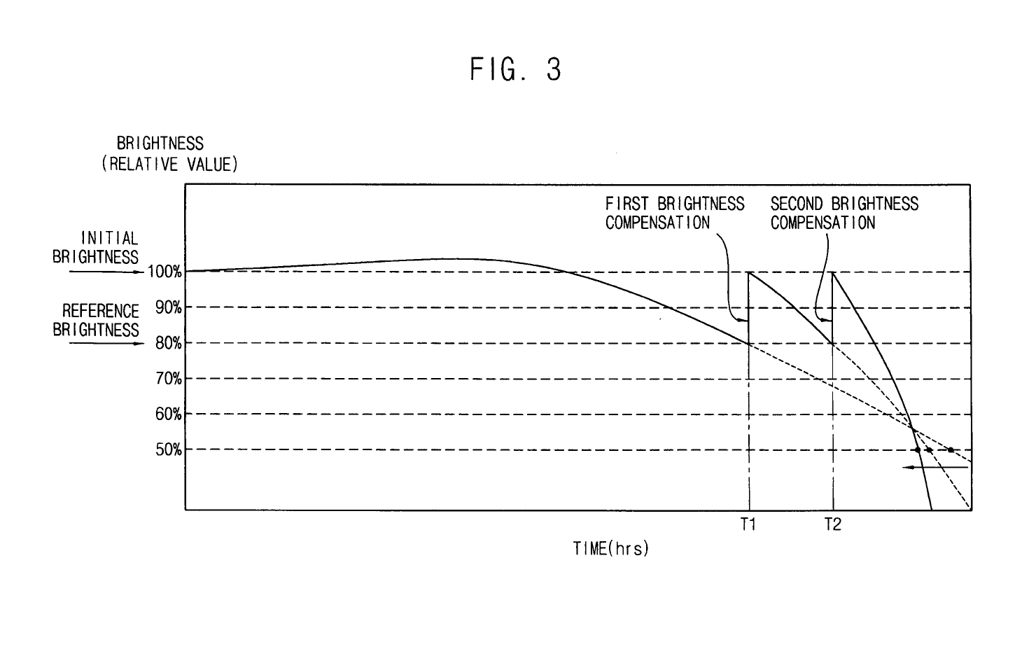

FIG. 3 is a graph illustrating the aging variation of the brightness of the light source according to an example embodiment of FIG. 2.

Referring to FIGS. 1 and 3, the reference brightness of the light source is predetermined based on the brightness aging characteristics of the test light source over time. In this case, the reference brightness of the light source is preferably predetermined by a customer's demand, and in the present example embodiment, the reference brightness is predetermined to be about 80% of the initial brightness.

When the reference brightness of the light source is predetermined, the number of the compensations of the light source and a value of the compensation brightness are predetermined at the same time, based on the brightness aging characteristics of the test light source. In this case, the number of the compensations of the light source is predetermined to be two, and the first compensation brightness and the second compensation brightness are predetermined to be substantially same as the initial brightness.

Thus, the first and second times T1 and T2 are automatically determined by the brightness aging characteristics of the test light source, the reference brightness of the light source, the number of the compensations, the first compensation brightness and the second compensation brightness.

In step S20, after the reference brightness is predetermined, the light source is driven at the initial power level until the first time T1. In this case, the brightness of the light source may slightly increase from the initial brightness as the time progresses, and then gradually decreases to the reference brightness at the first time T1.

In step S30, the light source is driven at the first compensation power level to have the first compensation brightness until the second time T2 from the first time T1.

In step S40, after the second time T2, the light source is driven at the second compensation power level to have the second compensation brightness. In this case, the brightness of the light source gradually decreases from the second compensation brightness at the second time T2 until the life of the light source is over.

The method for driving the light source according to the present example embodiment, the step predetermining the reference brightness may be omitted. For example, the light source may be driven according to the predetermined first and second times T1 and T2 instead of according to the predetermined reference brightness, if preferred by the customer. In this case, the first and second times T1 and T2 are predetermined by the brightness aging characteristics of the test light source, the reference brightness of the light source, the number of the compensations of the light source and the compensation brightness.

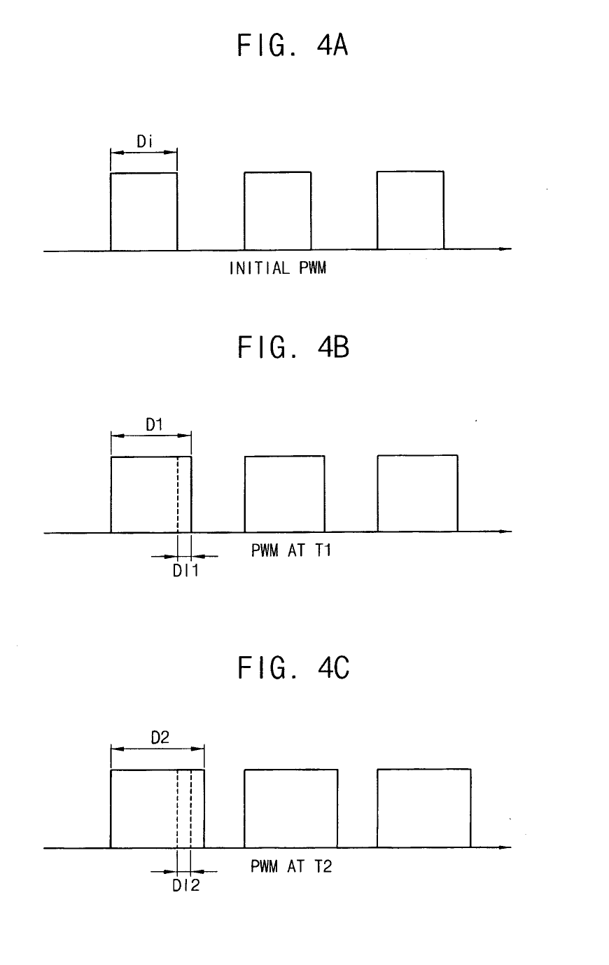

FIGS. 4A, 4B and 4C are waveform diagrams illustrating a process of increasing a driving power level via increasing a duty width of a pulse width modulation (PWM).

Referring to FIGS. 4A, 4B and 4C, for example, the light source may be driven through control of the PWM. In this case, the duty width of the PWM increases, so that the initial power may increase to the first compensation average power, or the first compensation power may increase to the second compensation average power.

Referring to FIGS. 2 and 4A, when the light source is driven at the initial average power, the PWM signal has an initial duty width Di.

Referring to FIGS. 2 and 4B, when the light source is driven at the first compensation average power, the PWM signal has a first duty width D1. In this case, the first duty width D1 is the sum of the initial duty width D1 and a first compensation duty width DI1.

Referring to FIGS. 2 and 4C, when the light source is driven at the second compensation average power, the PWM signal has a second duty width D2. In this case, the second duty width D2 is the sum of the first duty width D1 and a second compensation duty width DI2. For example, the second compensation duty width DI2 may be substantially same as the first compensation duty width DI1. Alternatively, the second compensation duty width DI2 may be different form the first compensation duty width DI1.

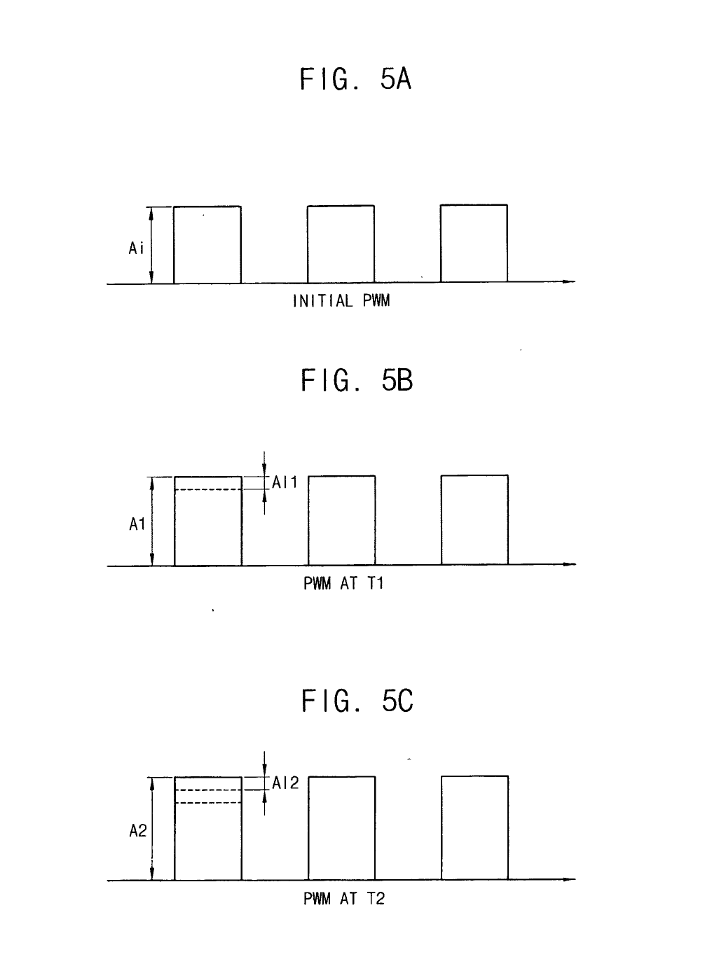

FIGS. 5A, 5B and 5C are waveform diagrams illustrating a process of increasing the average driving power via increasing an amplitude of the PWM.

Referring to FIGS. 5A, 5B and 5C, the amplitude of the PWM increases, so that the initial average power increases to the first compensation average power or the first compensation average power increases to the second compensation average power.

Referring to FIGS. 2 and 5A, when the light source is driven at the initial average power, the PWM signal has a first initial amplitude Ai.

Referring to FIGS. 2 and 5B, when the light source is driven at the first compensation average power, the PWM signal has a first amplitude A1. In this case, the first amplitude A1 is the sum of the first initial amplitude Ai and a first compensation amplitude AI1.

Referring to FIGS. 2 and 5C, when the light source is driven at the second compensation average power, the PWM signal has a second amplitude A2. In this case, the second amplitude A2 is the sum of the first amplitude A1 and a second compensation amplitude AI2. For example, the second compensation amplitude AI2 may be substantially same as the first compensation amplitude AI1. Alternatively, the second compensation amplitude AI2 may be different from the first compensation amplitude AI1.

According to the present example embodiment, when the brightness of the light source decreases to the reference brightness, the driving power applied to the light source is further increased to compensate the brightness of the light source, so that the light source is driven to have uniform brightness over time. For example, the light source is uniformly driven with a brightness greater than the reference brightness during the period for compensating the brightness.

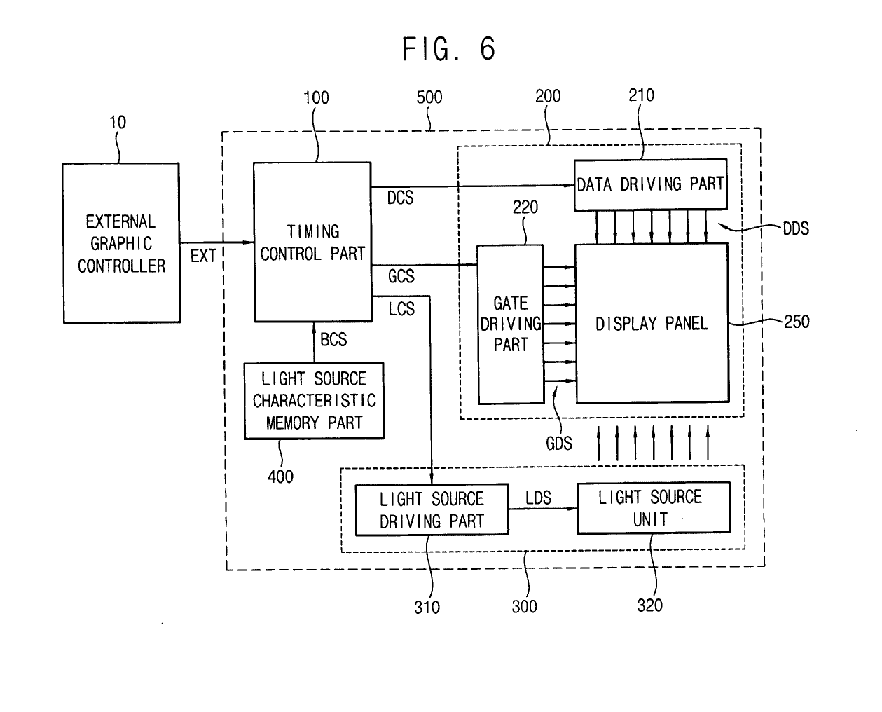

FIG. 6 is a block diagram illustrating a display apparatus 500 according to an example embodiment of the present invention.

Referring to FIG. 6, the display apparatus 500 according to the present example embodiment, includes a timing control part 100, a display unit 200, a backlight assembly 300 and a light source characteristic memory part 400.

The timing control part 100 receives an external signal EXT from an external graphic controller 10, and receives a brightness compensation control signal BCS from the light source characteristic memory part 400. The timing control part 100 outputs an image control signal and a light source control signal LCS in response to the external signal EXT and the brightness compensation control signal BCS. In this case, the image control signal includes a data control signal DCS and a gate control signal GCS.

The display unit 200 receives the image control signal from the timing control part 100, and receives light from the backlight assembly 300, to display an image. For example, the display unit 200 includes an image driving part (not shown) and a display panel 250.

The image driving part receives the image control signal from the timing control part 100, and outputs the image driving signal to the display panel 250 in response to the image control signal. For example, the image driving part includes a data driving part 210 and a gate driving part 220.

The data driving part 210 outputs a data driving signal DDS to the display panel 250, in response to the data control signal DCS applied from the timing control part 100. The gate driving part 220 outputs a gate driving signal GDS to the display panel 250, in response to the gate control signal GCS applied from the timing control part 100. In other words, the image driving signal includes the data driving signal DDS and the gate driving signal GDS.

The display panel 250 is controlled by the image driving signal applied from the image driving part, for example, the data driving signal DDS and the gate driving signal GDS, and displays the image by using the light applied from the backlight assembly 300.

For example, the display panel 250 includes a first substrate (not shown), a second substrate (not shown) opposite to the first substrate, and a liquid crystal layer (not shown) disposed between the first and second substrates.

The first substrate includes a signal line through which the image driving signal is transmitted, a thin film transistor (TFT) electrically connected to the signal line, and a pixel electrode electrically connected to the TFT and having a transparent conductive material. In this case, the signal line includes a gate line transmitting the gate driving signal GDS and a data line transmitting the data driving signal DDS.

For example, the second substrate includes a color filter corresponding to the pixel electrode and a common electrode formed over the entire substrate and having a transparent conductive material. For example, the color filter includes a red color filter, a green color filter and a blue color filter.

The liquid crystal layer is disposed between the first and second substrates, and an arrangement direction of liquid crystal molecules is altered by an electric field generated between the pixel electrode and the common electrode. When the arrangement direction of the liquid crystal molecules is changed, the liquid crystal layer changes transmissivity of the light passing through the liquid crystal layer.

For example, the backlight assembly 300 is disposed under the display unit 200, and provides the light to the display unit 200 in response to the light source control signal LCS applied from the timing control part 100. For example, the backlight assembly 300 includes a light source driving part 310 and a light source unit 320.

The light source driving part 310 receives the light source control signal LCS from the timing control part 100, and outputs the light source driving signal LDS to the light source unit 320 in response to the light source control signal LCS.

The light source unit 320 is controlled by the light source driving signal LDS applied from the light source driving part 310, to provide the light to the display panel 250. The light source unit includes a plurality of light sources emitting the light.

For example, the light sources may be the LEDs emitting a point light source. For example, the LEDs may include white LEDs or red, green and blue LEDs. Alternatively, the light sources may be the CCFLs or the HCFLs.

When the brightness of the light source degrades to the predetermined reference brightness, the light source driving part 310 increases the driving power level applied to the light source to drive the light source using the light source driving signal LDS, so that the brightness of the light source is compensated.

For example, the light source driving part 310 controls the light sources as follows. The light source driving part 310 may respectively control each of the light sources, or may simultaneously control all of the light sources. In addition, when the light sources include the LEDs that are formed in a plurality of blocks, the light source driving part 310 may individually control each of the blocks including the LEDs.

The light source characteristic memory part 400 stores light source data including a variety of information on the brightness compensation of the light source. The light source data includes the information on the reference brightness, information on the number of the compensations of the light source, the compensation brightness of the light source, the compensation power of the light source, the compensation time of the light source and so on. The information on the light source data is obtained through the brightness aging characteristics of the light source over time.

The light source characteristic memory part 400 outputs the brightness compensation control signal BCS including the light source data to the timing control part 100, to control the light source driving part 310.

The light source driving part 310 is controlled by the light source characteristic memory part 400 as follows.

Firstly, a test light source, substantially the same kind as the light source, is driven by a constant power for a long time, and then the brightness aging variation of the light emitted from the test light source is measured over time. The brightness aging characteristics of the test light source according to the time is considered, and then the reference brightness, the number of compensations of the light source, the compensation brightness of the light source, the compensation power of the light source, the compensation time of the light source and so on are predetermined accordingly, and the foregoing information is stored in the light source characteristic memory part 400. For example, the light source characteristic memory part 400 may be an electrically erasable and programmable read only memory (EEPROM) and may include various memory devices.

For example, the light source characteristic memory part 400 stores the brightness variation characteristic of the test light source over time, the reference brightness, the number of compensations of the light source, the compensation brightness of the compensation light source and the compensation power of the light source. The compensation time of the light source may be automatically determined by the variety of information stored in the light source characteristic memory part 400. Alternatively, the light source characteristic memory part 400 stores the information on the compensation time of the light source, so that the display apparatus 500 may be driven.

Based on the foregoing information, the light source characteristic memory part 400 outputs the brightness compensation control signal BCS to the timing control part 100. The timing control part 100 outputs the light source control signal LCS to the light source driving part 310 in response to the external signal EXT and the brightness compensation control signal BCS.

The light source driving part 310 outputs the light source driving signal LDS for compensating the brightness of the light source to the light source unit 320 in response to the light source control signal LCS.

The light source unit 320 provides the light having more uniform brightness over time, to the display panel 250 in response to the light source driving signal LDS. For example, when the brightness of the light source decreases to the reference brightness, the light source driving signal LDS increases the driving power applied to the light source to control the light source, so that the brightness of the light source may be compensated. Thus, the light source unit 320 may emit the light having the brightness larger than the reference brightness for a greater length of time than without compensation.

When the light source of the light source unit 320 is the LEDs, the LEDs may include the white LEDs. Alternatively, the LEDs may include the red, green and blue LEDs.

In this case, when the LEDs only include the white LEDs, the light source characteristic memory part 400 only stores the information on the white LED. For example, the brightness compensation control signal BCS, the light source control signal LCS and the light source driving signal LDS only include the data compensating the white LEDs.

However, when the LEDs include the red, green and blue LEDs, the light source characteristic memory part 400 stores the information on the red, green and blue LEDs. For example, the brightness compensation control signal BCS, the light source control signal LCS and the light source driving signal LDS include the data compensating the red, green and blue LEDs, respectively.

For example, the light source control signal LCS or the light source driving signal LDS may be the PWM signal. When the light source control signal LCS or the light source driving signal LDS are the PWM signal, one of the duty width or the amplitude of the PWM signal may be altered to change the driving power applied to the light source unit 320 more easily.

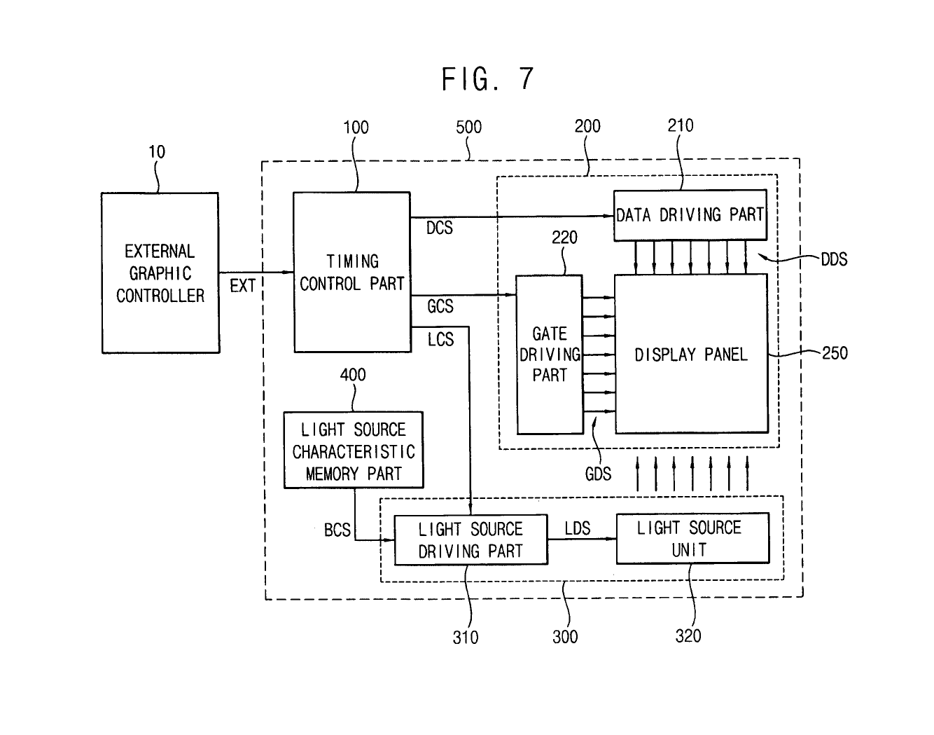

FIG. 7 is a block diagram illustrating a display apparatus 500 according to another example embodiment of the present invention. The display apparatus of the present example embodiment is substantially same as in the previous example embodiment in FIG. 6 except the light source characteristic memory part 400. Thus, the same reference numerals will be used to refer to the same or like parts as those described in the previous example embodiment in FIG. 6 and any further repetitive explanation concerning the above elements will be omitted.

Referring to FIG. 7, the light source characteristic memory part 400 directly outputs the brightness compensation control signal BCS to the light source driving part 310.

The light source driving part 310 outputs the light source driving signal LDS in response to the brightness compensation control signal BCS applied from the light source characteristic memory part 400 and the light source control signal LCS applied from the timing control part 100, to drive the light source unit 320.

Accordingly, the light source characteristic memory part 400 may indirectly control the light source driving part 310 through the timing control part 100 as illustrated in FIG. 6, but may directly control the light source driving part 310 as illustrated in FIG. 7.

In this case, when the light source characteristic memory part 400 directly controls the light source driving part 310, the light source characteristic memory part 400 may be preferably included as an element in the backlight assembly 300.

According to the present invention, when the brightness of the light source decreases to the predetermined reference brightness, the driving power applied to the light source is further increased to compensate the brightness of the light source, so that the light source may be driven to have uniform brightness over an extended time. Thus, the display apparatus may display the image having uniform brightness for at least a warranty period.

Having described the example embodiments of the present invention and its advantage, it is noted that various changes, substitutions and alterations can be made herein without departing from the spirit and scope of the invention as defined by appended claims.

What is claimed is:

1. A method for driving a light source, the method comprising:
driving a light source at an initial power until a first time when initial brightness of the light source decreases to a reference brightness; and
driving the light source at a first compensation power after the first time, so that the light source has a first compensation brightness.

2. The method of claim 1, wherein the first time is predetermined by brightness aging characteristics of the light source over time and by the reference brightness.

3. The method of claim 1, further comprising predetermining the reference brightness by using the brightness aging characteristics of the light source 15 over time to determine the first time.

4. The method of claim 1, wherein the reference brightness is in a range between about 70% and about 90% of the initial brightness.

5. The method of claim 1, wherein the first compensation brightness is in a range between about 90% and about 100% of the initial brightness.

6. The method of claim 1, wherein the initial power is changed to the first compensation power by altering at least one of a duty width of a pulse width modulation (PWM) and an amplitude of a signal that controls the light source.

7. The method of claim 1, wherein the light source comprises a light emitting diode (LED).

8. The method of claim 1, wherein the light source is driven at the first compensation power until a second time when the first compensation brightness of the light source decreases to the reference brightness.

9. The method of claim 8, further comprising driving the light source at a second compensation power after the second time, so that the light source has a second compensation brightness.

10. The method of claim 9, wherein the second compensation brightness is substantially same as the first compensation brightness.

11. The method of claim 9, wherein the first compensation power is changed to the second compensation power by altering at least one of a duty width of a pulse width modulation (PWM) and an amplitude of a signal that controls the light source.

12. A backlight assembly comprising:
a light source emitting light; and
a light source driving part driving the light source by changing a driving power applied to the light source when brightness of the light source decreases to a reference brightness, to compensate the brightness of the light source.

13. The backlight assembly of claim 12, further comprising a light source characteristic memory part storing light source data corresponding to brightness compensation of the light source and providing the light source data to the light source driving part.

14. The backlight assembly of claim 13, wherein the light source data comprises at least one of information on the reference brightness, information on compensation brightness compensating the brightness of the light source, and information on the number of compensations of the light source.

15. The backlight assembly of claim 13, wherein the light source data comprises information on time for compensating the brightness of the light source.

16. The backlight assembly of claim 12, wherein the light source comprises a light emitting diode (LED).

17. A display apparatus comprising:
a timing control part outputting an image control signal and a light source control signal in response to an external signal;
a display unit outputting an image in response to the image control signal; and
a backlight assembly including:
a light source emitting light and providing the light to the display unit; and
a light source driving part driving the light source by changing a driving power applied to the light source when brightness of the light source decreases to a reference brightness in response to the light source control signal, to compensate the brightness of the light source.

18. The display apparatus of claim 17, further comprising a light source characteristic memory part storing light source data corresponding to brightness compensation of the light source and providing the light source data to the light source driving part.

19. The display apparatus of claim 18, wherein the timing control part receives the light source data from the light source characteristic memory part, and outputs the light source control signal corresponding to the light source data to the light source driving part.

20. The display apparatus of claim 18, wherein the light source driving part receives the light source data from the light source characteristic memory part, and drives the light source in response to the light source data.
